(19) United States
(12) Patent Application Publication
(10) Pub. No.: US 2022/0351556 A1
(43) Pub. Date: Nov. 3, 2022

(54) VEHICLE CONTROLLER METHOD AND APPARATUS

(71) Applicant: Jason Houle, Forest Lake, MN (US)

(72) Inventor: Jason Houle, Forest Lake, MN (US)

(21) Appl. No.: 17/735,439

(22) Filed: May 3, 2022

Related U.S. Application Data
(60) Provisional application No. 63/183,196, filed on May 3, 2021.

(51) Int. Cl. G07C 5/08

(52) U.S. Cl. CPC G07C 5/0808

(57) ABSTRACT

The present invention relates to a method and apparatus for sending information from a vehicle's onboard computing device to a programmable controller to operate one or more accessories, including after-market accessories, automatically.

### BACKGROUND OF THE INVENTION

### Field of the Invention

The present invention relates to a method and apparatus for using a vehicle controller and the information available from it, and more particularly to controlling after-market components through real-time feedback to improve the operation of the vehicle and the vehicle operator's experience.

### Background

Virtually all modern vehicles have on board diagnostic (“OBD”) capability. OBD is an automotive term referring to a vehicle's self-diagnostic and reporting capability. OBD systems give the vehicle owner or repair technician access to the status of the various vehicle sub-systems. An OBD port outputs information from the vehicles electronic control unit, and allows for monitoring a host of a vehicles systems, such as engine performance, exhaust, fuel system, ignition, transmission, brakes, lights, and any other system that is electronically or computer controlled. The information can be used by technicians to diagnose problems, search for error codes, and can serve as a “black box” of sorts in an accident or other event that requires investigation.

Until this point, the full potential of OBD to provide real-time monitoring and control has not been realized. The OBD information could be used to benefit the operators of vehicles as well as others in ways not described in the prior art.

Thus a need exists for a method and apparatus to better use OBD systems.

### A BRIEF DESCRIPTION OF THE FIGURES

FIG. 1 is a block diagram of the components of the present invention.

FIG. 2 is a block diagram of the components of another embodiment of the invention.

FIG. 3 is a chart of uses of the invention.

### DETAILED DESCRIPTION OF THE INVENTION

The present invention relates to a method and apparatus for using OBD systems of vehicles. The vehicles of the present invention can be any type—from commercial vehicles such as trucks and vans, to passenger vehicles, to utility vehicles such as utility terrain or all-terrain vehicles, snowmobiles, motorcycles, and the like.

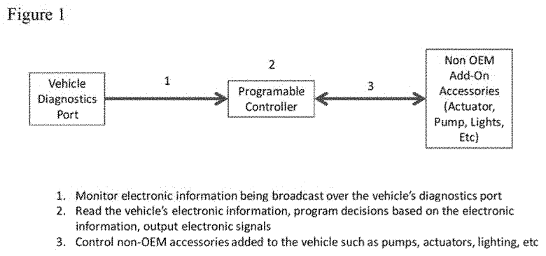

FIG. 1 shows a block diagram of a configuration of the present invention. Information from a vehicles OBD is accessed from the vehicle diagnostic port, through communication link 1 which broadcasts electronic information about the various systems of the vehicle. The information from the vehicle diagnostic port is provided to a programmable controller 2 which reads the electronic and digital information provided from the vehicle diagnostic port and makes program decisions based on it. A two-way communication link 3 is established between the controller and one or more accessories, whereby the controller alters the state of the accessories based on the information from the vehicle diagnostic port. The accessories can include OEM parts such as actuators, electrical relays, pumps, lights, and the like—including accessories described herein.

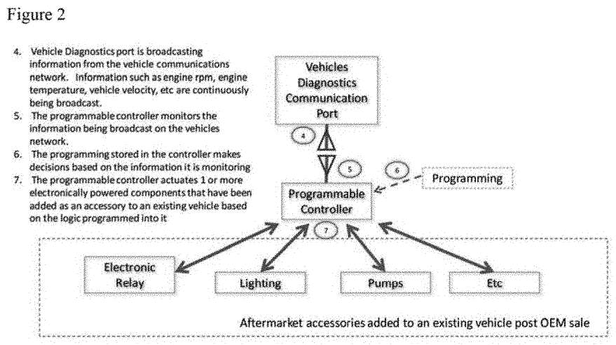

FIG. 2 is a block diagram of further embodiment of the invention. The port communicates through communication link 4 to the controller. The controller 5 monitors various vehicle parameters and makes decisions based on programming instructions 6 stored in the controller 5. Communication link 7 connects to various accessories and provides a means for the controller 5, under the control of the program 6, to actuate the accessories in view of the vehicle information.

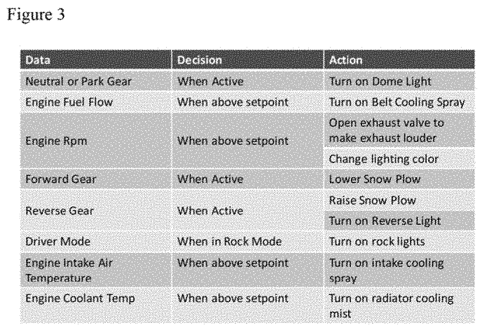

FIG. 3 lists some of the uses of the present invention, however, the invention is not so limited. The table includes exemplary data which the controller can monitor from the vehicle diagnostic port, the decision trigger for the program, and an action that can be taken through an after-market add on part, or through an existing vehicle device. For example, when the vehicle is in neutral or park, a dome light or accessory light can be turned on; if the fuel flow is above a certain point (indicating heavy engine use) a sprayer can be activated to cool parts like belts that could be getting too hot; if engine RPM is above a certain level an exhaust port can be opened or a light turned on; if the vehicle is placed in a forward gear a snow plow blade can be lowered (during plowing); if the vehicle is placed in reverse the blade can be raised and reverse lights turned on; if the vehicle has different drive modes (for example a crawler mode) special lights can be turned on; if the engine intake air temperature exceeds a set point then a sprayer can be turned on to cool engine parts; if the coolant temperature exceeds a set point a radiator cooling mister can be activated. These and other actions are contemplated by the present invention.

The following is a more detailed description of embodiments of the present invention based off production utility terrain vehicles (UTV) models.

1. Belt Aid

The belt cooling system allows the user of the UTV to drive the vehicle without the concern of over stressing the belt to failure. The system is monitoring the OBD fuel flow data through the can connection port that is directly connected to the controller. The controller then has fuel flow set points that are programmed into the controller depending on the HP rating of the UTV. When these set points are achieved the controller will then send power to the solenoid that activates the belt cooling system to activate power to the pump to turn on and spray liquid into the belts cooling intake tube to be then sucked into the belt chamber and thus cooling the belt. The system will continue to spay until the controller does not see the required information from the OBC through the can connection to send power. The system is armed by a basic power switch, with the capability to turn the system on and off.

2. Reverse Lights.

Currently the UTVs do not have or come with any automated reverse light options, and the controller will be able to see the UTS's “stream” of information from the OBD and determine that the driver has put the vehicle into reverse. This will then trigger the controller to send power through a relay and then to the reverse lights. The lights will then be on until the vehicle is either shut off and the power from the OBD is no longer streaming or the UTV is taken out of reverse. Thus, with no reverse input to the controller the power that is sent to the solenoid and to the light to turned off.

3. Plow

The UTV's that are installed with plows would now be able to be know from the information streamed from the OBD to know when to lifted and put down the plow. First, the user installs power signal from the plow to the controller to turn it on and off. This would allow the user to choose if they want this option to happen during the plowing, or turn it off completely when the plow is not being used or is not present. After the power is turned on and the vehicle is shifted into forward the plow will drop because the OBD streamed information to the controller that the UTV is in a forward gear indicating plowing. This allows the controller to send power to the plow controller to lower the plow and stop at a predetermined distance. When the vehicle is then put into reverse, the controller will see the information streamed from the OBD that it is in reverse and then in turn send power to the controller to raise the plow. Thus, ensuring the user will only have to drive back and forth rather than have to control the plow manually while driving.

The above specification and accompanying Figure are for illustrative use only. The scope of the present invention is defined by the claims. The present invention may be embodied in other specific forms without departing from the spirit or essential attributes of it, and it is thus desired that the present embodiment be considered in all respects as illustrative and not restrictive, reference being made to the appended claims rather than to this description to indicate the scope of the invention. Those of ordinary skill in the art that have the disclosure before them will be able to make modifications and variations therein without departing from the scope of the invention.

1. A method for utilizing a vehicles on board diagnostics, comprising:
sending signals between a vehicle diagnostic port, a programmable controller, and a vehicle accessory; and
determining the state of the accessory based on the signals from the port under the control of computer programming instructions operating in the controller.

2. The method of claim 1 further comprising the step of monitoring vehicle operational parameters sent from the port, and using this information to determine the state of the accessory pursuant to the programming in the controller.

3. The method of claim 2 whereby the gear of the vehicle is monitored and the accessary comprises a dome light which is turned on and off in response to the gear.

4. The method of claim 2 whereby the engine rpm level of the vehicle is monitored and the accessary comprises an exhaust port and an indicator light which are turned on and off in response to the rpm level.

5. The method of claim 2 whereby the engine fuel flow of the vehicle is monitored and the accessary comprises a belt cooling sprayer which is turned on and off in response to the fuel flow.

6. The method of claim 2 whereby the gear of the vehicle is monitored and the accessary comprises a snow plow which is lowered when the vehicle is in a forward gear.

7. The method of claim 2 whereby the gear of the vehicle is monitored and the accessary comprises a snow plow and a back up indicator light which when the vehicle is in a rearward gear the plow is raised and the light is activated.

8. The method of claim 2 whereby the driver mode of the vehicle is monitored and the accessary comprises a rock light which is turned on and off in response to the mode.

9. The method of claim 2 whereby the engine intake air temperature of the vehicle is monitored and the accessary comprises an intake cooling sprayer which is turned on and off in response to the temperature.

10. The method of claim 2 whereby the engine coolant temperature of the vehicle is monitored and the accessary comprises a radiator cooling sprayer which is turned on and off in response to the temperature.

11. The method of claim 2 where the vehicle is an utility terrain vehicle, and the fuel flow of the vehicle is monitored and the accessory comprises a belt cooling system which is turned on and off in response to the fuel flow.

12. The method of claim 2 where the vehicle is an utility terrain vehicle, and the gear of the vehicle is monitored and the accessary comprises a reverse light which is turned on and off in response to the gear.
